(19) United States
(12) Patent Application Publication
(10) Pub. No.: US 2019/0268661 A1
(43) Pub. Date: Aug. 29, 2019

(54) DISPLAY DEVICE FOR IDENTIFYING PREFERENCE OF CONTENTS, BASED ON INTERNET OF THINGS (IOT) DEVICE

(71) Applicant: SAMSUNG ELECTRONICS CO., LTD., Suwon-si (KR)

(72) Inventors: Jisun PARK, Suwon-si (KR); Jaehwang LEE, Suwon-si (KR)

(21) Appl. No.: 16/281,424

(22) Filed: Feb. 21, 2019

(30) Foreign Application Priority Data
Feb. 23, 2018 (KR) 10-2018-0021752

(51) Int. Cl. H04N 21/475; H04N 21/431; H04N 21/422; H04N 21/45; H04N 21/466

(52) U.S. Cl. CPC H04N 21/4755; H04N 21/431; H04N 21/4665; H04N 21/4508; H04N 21/4222

(57) ABSTRACT

Disclosed is a display device. The display device includes an output device comprising output circuitry; communication circuitry configured to communicate with at least one external device and an external server; and a processor operatively coupled with the output device and the communication circuitry, wherein the processor is configured to: identify a user's preference based on at least one of: first preference information, second preference information, and third preference information, wherein the first preference information includes contents preference information input by a user, the second preference information includes control information of the display device and/or playback history information of contents output on the output device, and the third preference information includes information received from the at least one external device and/or the external server; receive contents information of interest corresponding to the user's preference from the external server via the communication circuitry; and output the received contents information of interest and/or notification for the received contents information of interest through the output device.

### CROSS-REFERENCE TO RELATED APPLICATION

This application is based on and claims priority under 35 U.S.C. § 119 to Korean Patent Application No. 10-2018-0021752, filed on Feb. 23, 2018, in the Korean Intellectual Property Office, the disclosure of which is incorporated by reference herein its entirety.

### BACKGROUND

### 1. Field

The present disclosure relates to a technology for recommending contents.

### 2. Description of Related Art

Display devices (e.g., TV devices) have actively evolved away from a passive service method of providing a service corresponding to a user input. For example, a display device may analyze a user's preference, based on usage history information (e.g., input history information) and may provide necessary service information (e.g., contents information) to the user before an input of the user, based on the analyzed preference. The input history information may include, for example, an input keyword, a selected service (e.g., selected contents), and the like.

A display device in the related art may identify a user's preference, based on explicit information (e.g., history information) and may recommend contents, based on the identified preference. Because the display device in the related art merely recommends the contents based on the explicit information, the display device fails to recommend contents appropriate for user context (or according to implicit information).

The above information is presented as background information only to assist with an understanding of the present disclosure. No determination has been made, and no assertion is made, as to whether any of the above might be applicable as prior art with regard to the present disclosure.

### SUMMARY

In accordance with an example aspect of the present disclosure, a display device includes an output device comprising output circuitry, communication circuitry that communicates with at least one external device and/or an external server, and a processor operatively coupled with the output device and the communication circuitry. The processor is configured to identify a user's preference based on at least one of: first preference information including contents preference information input by a user, second preference information including control information of the display device and/or playback history information of contents output on the output device, and third preference information including information received from the at least one external device and/or the external server, to receive contents information of interest corresponding to the user's preference from the external server via the communication circuitry, and to output the received contents information of interest and/or notification for the received contents information of interest through the output device.

In accordance with another example aspect of the present disclosure, a server for providing contents of interest includes communication circuitry configured to communicate with at least one external IoT terminal and a display device, and a processor. The processor is configured to identify a user's preference based on at least one of: information received from the display device and information received from the at least one external IoT terminal, to generate contents information of interest corresponding to the identified preference of the user, and to transmit the generated contents information of interest and/or notification for the generated contents information of interest to the display device and/or the at least one external IoT terminal via the communication circuitry.

In accordance with another example aspect of the present disclosure, a display device includes a memory, a display, communication circuitry configured to communicate with at least one IoT device in a home, and a processor operatively coupled with the memory, the display, and the communication circuitry. The processor is configured to output contents through the display, to receive status information of the at least one IoT device from the at least one IoT device via the communication circuitry, to adjust a preference associated with the contents based on the received status information, and to control the memory to store the adjusted preference in the memory.

Other aspects, advantages, and salient features of the disclosure will become apparent to those skilled in the art from the following detailed description, which, taken in conjunction with the annexed drawings, discloses various example embodiments of the present disclosure.

### BRIEF DESCRIPTION OF THE DRAWINGS

The above and other aspects, features, and advantages of certain embodiments of the present disclosure will be more apparent from the following detailed description, taken in conjunction with the accompanying drawings, in which:

FIG. 1 is a block diagram illustrating an example configuration of a contents recommendation system according to an embodiment;

FIG. 2 is a block diagram illustrating an example configuration of a display device according to an embodiment;

FIG. 3 is a diagram illustrating an example recommendation setting UI screen for contents according to an embodiment;

FIG. 4 is a diagram illustrating an example arrangement of a plurality of IoT devices and a display device in a home according to an embodiment;

FIG. 5 is a flowchart illustrating an example method for identifying a preference for IoT-based contents according to an embodiment;

FIG. 6 is a flowchart illustrating an example method for adjusting a preference associated with contents according to an embodiment;

FIG. 7 is a flowchart illustrating an example method for recommending contents according to an embodiment;

FIG. 8 is a flowchart illustrating an example method for recommending contents in accordance with the magnitude of a preference according to an embodiment;

FIG. 9 is a flowchart illustrating an example method for recommending contents in accordance with user context according to an embodiment;

FIG. 10 is a block diagram illustrating an example configuration of a display device according to an embodiment; and

FIG. 11 is a block diagram illustrating an example configuration of a server device according to an embodiment.

With regard to the description of the drawings, similar reference numerals may be used to refer to similar or related components.

### DETAILED DESCRIPTION

Aspects of the present disclosure address at least the above-mentioned problems and/or disadvantages and provide at least the advantages described below. Accordingly, an example aspect of the present disclosure is to provide a display device for identifying a preference of contents, based on status information of an Internet of Things (IoT) device.

Hereinafter, various example embodiments of the disclosure may be described with reference to accompanying drawings. Accordingly, those of ordinary skill in the art will recognize that various modifications, equivalents, and/or alternatives on the various example embodiments described herein can be variously made without departing from the scope and spirit of the present disclosure.

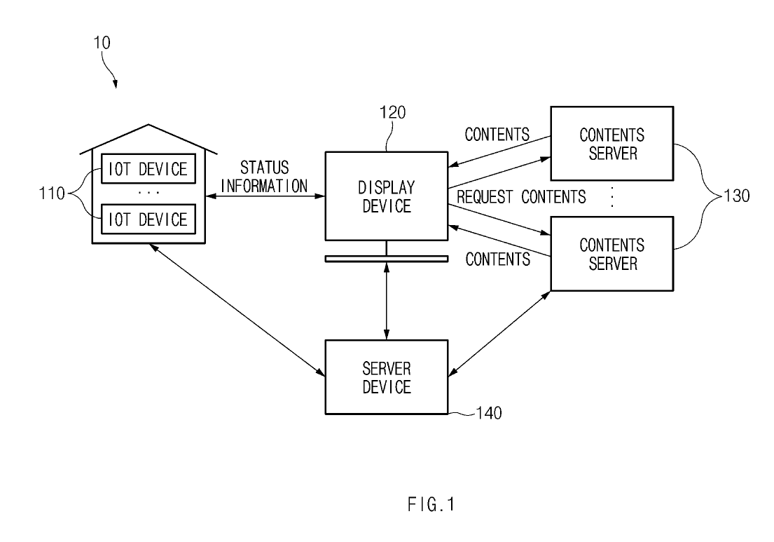

FIG. 1 is a block diagram illustrating an example configuration of a contents recommendation system 10 according to an embodiment.

Referring to FIG. 1, according to an embodiment, the contents recommendation system 10 may include at least one Internet of Things (IoT) device 110, at least one contents server 130, and a display device 120. FIG. 1 illustrates an example in which the contents recommendation system 10 includes a plurality of IoT devices 110 and a plurality of contents servers 130. However, the contents recommendation system 10 is not limited thereto. For example, the contents recommendation system 10 may include one IoT device 110 and one contents server 130. In an embodiment, some of the components may be omitted, or the contents recommendation system 10 may further include additional components. In an embodiment, some of the components may be combined together to form one object, but the object may perform the functions of the corresponding components before the combination. Input/output relationships illustrated in FIG. 1 are merely illustrative for the convenience of description, and the present disclosure is not limited thereto.

According to an embodiment, the at least one IoT device 110 may communicate with the at least one contents server 130 and the display device 120 via, for example, a home IoT network. The IoT network may include a network such as, for example, and without limitation, wireless LAN (WiFi), Bluetooth, Zigbee, or the like. The IoT network may include a network such as, for example, and without limitation, LTE-M (Long Term Evolution-Machine Type Communication (LTE-MTC)), Long RAnge (LoRA), or the like. The at least one IoT device 110 may transmit status information in response to a request of the display device 120. The status information may include at least one of, for example, operation time information and/or operation content information. The operation content information may include, for example, information representing operation content of each IoT device, such as on, off, various types of inputs, various types of settings, door opening, door closing, or the like, but is not limited thereto. For example, the at least one IoT device 110 may include, for example, and without limitation, an air conditioner, a washing machine, a refrigerator, an oven, an induction stove, an microwave oven, a vacuum cleaner, lighting, a massage machine, a wearable device, a speaker, a user terminal (e.g., a smartphone), or the like.

According to an embodiment, the at least one contents server 130 may be a server that provides contents. The at least one contents server 130 may include, for example, and without limitation, a web server that provides web contents, a broadcaster's server that provides broadcast contents (e.g., real-time broadcast contents or VOD broadcast contents), or the like.

According to an embodiment, the display device 120 may output contents provided through the at least one contents server 130. The display device 120 may include, for example, and without limitation, a TV device capable of playing contents, a device capable of receiving and playing TV broadcast contents, or the like. For example, when contents are selected through an input device and requested to be played, the display device 120 may request the selected contents from the at least one contents server 130, receive the contents from the at least one contents server 130 in response to the request, and play the received contents (e.g., output the received contents on a display). The contents may be, for example, contents associated with a preference.

According to an embodiment, the display device 120 may output contents, receive status information of the at least one IoT device 110 from the at least one IoT device 110, adjust (e.g., raise or lower) a preference for the contents being played, based on the received status information, and store the adjusted preference in a memory. For example, the display device 120 may identify whether an IoT device in use is present among the at least one IoT device 110, based on the status information of the at least one IoT device 110 and may lower the preference for the contents being played, when identifying that an IoT device in use is present. The display device 120 may raise the preference for the contents when identifying that there is no IoT device in use.

According to an embodiment, when the adjusted preference of the contents is lower than a specified value, the display device 120 may determine that a user does not have an interest in the contents being played and may recommend contents corresponding to the status information of the at least one IoT device 110 to replace the contents being played. The display device 120 may recommend contents with a relatively high preference among the contents corresponding to the status information of the at least one IoT device 110. The display device 120, when requested to play the recommended contents, may raise the preference for the recommended contents.

A server device 140 may, for example, and without limitation, collect the status information of the at least one IoT device 110 and information on the contents being played, predict the user's behavior, based on the collected information, predict a relation between the user's behavior and the contents being played, determine the user's preference for the contents, or the like. The server device 140 may determine personalized contents of interest, based on the user's preference and may generate contents summary information on the personalized contents of interest. The server device 140 may determine a notification form of the generated contents summary information.

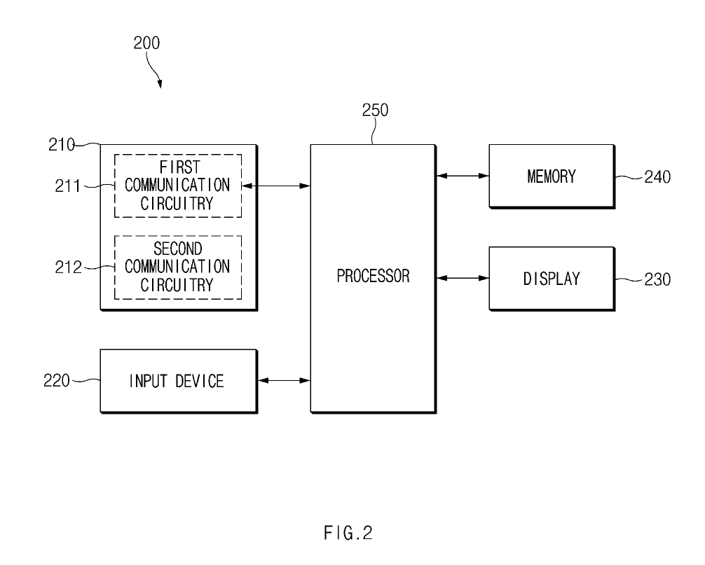

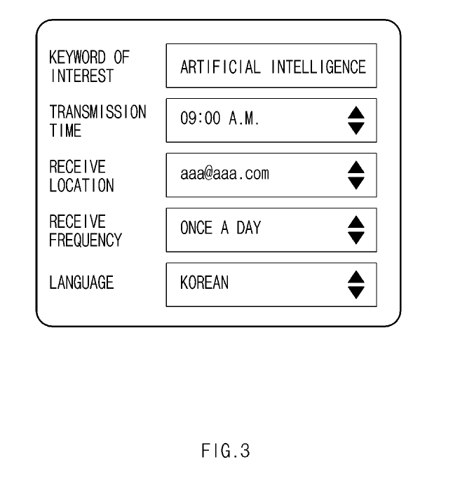

FIG. 2 is a block diagram illustrating an example configuration of a display device 200 according to an embodiment. FIG. 3 is a view illustrating a recommendation setting UI screen for contents according to an embodiment.

Referring to FIG. 2, according to an embodiment, the display device 200 (e.g., the display device 120 of FIG. 1) may include communication circuitry 210, an input device (e.g., including input circuitry) 220, a display 230, a memory 240, and a processor (e.g., including processing circuitry) 250. In an embodiment, some of the components may be omitted, or the display device 200 may further include additional components. In an embodiment, some of the components may be combined together to form one object, but the object may identically perform the functions of the corresponding components before the combination. Input/output relationships illustrated in FIG. 2 are merely illustrative for the convenience of description, and the present disclosure is not limited thereto.

According to an embodiment, the communication circuitry 210 may include first communication circuitry 211 and second communication circuitry 212. The first communication circuitry 211 may establish a communication channel for communicating with the at least one IoT device 110. For example, the first communication circuitry 211 may transmit, to an IoT network, information (e.g., a request for status information) from the processor 250 by transforming the information into a form that is transmittable via the communication channel for communication with the at least one IoT device 110, and may output status information received from the at least one IoT device 110 by transforming the status information into a form that is interpretable by the processor 250. The second communication circuitry 212 may establish a communication channel for communicating with the at least one contents server 130. For example, the second communication circuitry 212 may transmit, to a specified communication network, information (e.g., a request for contents) from the processor 250 by transforming the information into information appropriate for specified communication with the at least one contents server 130, and may output contents received from the at least one contents server 130 by transforming the contents into a form that is interpretable by the processor 250.

According to an embodiment, the input device 220 may include various input circuitry and receive or detect a user input. For example, the input device 220 may include, for example, and without limitation, at least one of a touch sensor formed on the display 230, third communication circuitry in communication with a remote control device, an input button provided on the display device 200, or the like. The third communication circuitry may communicate with the remote control device (e.g., a remote controller, a mouse, or the like) using various communication schemes such as, for example, and without limitation, Bluetooth, NFC, IR communication, USB, PS2, and the like. The input button, which is provided on the display device 200, may include at least one of, for example, and without limitation, a power button, a channel change button, a volume control button, or the like.

According to an embodiment, the display 230 may output contents according to a command of the processor 250. The display 230 may include, for example, and without limitation, a Liquid Crystal Display (LCD), a Light-Emitting Diode (LED) display, an Organic Light-Emitting Diode (OLED) display, a curved display, an electronic paper display, or the like. The display 230 may display, for example, various types of contents (e.g., text, images, videos, icons, symbols, and/or the like) to a user.

According to an embodiment, the memory 240 may store commands or data associated with at least one other component of the display device 200. For example, the memory 240 may store instructions for playing contents. The memory 240 may store instructions for associating the contents with a preference. In another example, the memory 240 may store instructions for adjusting the preference associated with the contents, based on the status information of the at least one IoT device 110. In another example, the memory 240 may store instructions for identifying usage context of the IoT device 110, based on the status information of the IoT device 110. In another example, the memory 240 may store contents history information. The contents history information may include, for example, information on the previously output contents, status information of at least one IoT device corresponding to the previously output contents, and information on a preference associated with the previously output contents.

According to an embodiment, the processor 250 may include various processing circuitry and perform operations or data processing associated with control and/or communication of at least one other component of the display device 200 by using the instructions stored in the memory 240. The processor 250 may include various processing circuitry, such as, for example, and without limitation, at least one of, for example, a Central Processing Unit (CPU), a Graphics Processing Unit (GPU), a microprocessor, an application processor, an Application Specific Integrated Circuit (ASIC), Field Programmable Gate Arrays (FPGA), or the like, and may have one or a plurality of cores.

In an embodiment, the processor 250 may output contents through the display 230, receive status information of the at least one IoT device 110 from the at least one IoT device 110 via the first communication circuitry 211, adjust a preference associated with the contents, based on the received status information, and store the adjusted preference in the memory 240. For example, when identifying information (e.g., the program name) of newly output contents, the processor 250 may associate the identified information of the contents with the default preference (e.g., 50 points) and may store the associated information in the memory 240. The processor 250 may adjust the default preference, based on the received status information. The contents may be, for example, contents that the processor 250 receives from the at least one contents server 130 via the second communication circuitry 212. In another example, the contents may be contents, at least part of which is stored in the memory 240. The status information may include at least one of, for example, operation time information or operation content information. The operation content information may include, for example, information representing operation content such as on, off, various types of inputs, door opening, or door closing.

According to an embodiment, the processor 250 may identify whether an IoT device in use is present, based on the received status information and may differently adjust the preference according to a presence or absence of an IoT device in use. For example, the processor 250 may lower the preference when an IoT device in use is present. In another example, the processor 250 may raise the preference associated with the contents when there is no IoT device in use.

According to an embodiment, the processor 250 may identify the user's operation time for the at least one IoT device 110, based on the received status information, and when the operation time overlaps contents output time, the processor 250 may identify that an IoT device in use is present. The processor 250 may identify, for example, operation time requiring the user's manual operation, such as door opening/closing time, on/off time, various types of input (or setting) time, or the like.

According to various embodiments, the processor 250 may vary the degree to which the preference is lowered, based on the distance between the display device 200 and an IoT device in use. For example, when the IoT device in use is located more than a specified distance from the display device 200, the processor 250 may lower the preference more than when the IoT device in use is located less than the specified distance from the display device 200. The specified distance may be, for example, a distance at which the user cannot watch the display device 200, and may be set to correspond to an environment in the home (e.g., the distance between the display device and at least one IoT device in the home). In this case, the distance between a fixed device among the at least one IoT device 110 and the display device 200 in the home has already been set, and the processor 250 may identify the distance between the display device 200 and the IoT device in use, based on the set information. For a movable device among the at least one IoT device 110, the processor 250 may identify the distance between the movable device and the display device 200, based, for example, on the strength of a signal received from the movable device (e.g., a Received Signal Strength Indicator (RSSI)). A relationship between the signal strength and the distance may be experimentally determined.

According to an embodiment, the processor 250 may vary the degree of adjustment of the preference, based on characteristics of an IoT device in use. For example, when the IoT device in use is a first device requiring more user concentration, the processor 250 may lower the preference more than when the IoT device in use is a second device requiring less user concentration. The first device may be, for example, a portable terminal, a gas stove, a vacuum cleaner, a speaker, or the like. The second device may be, for example, a robot vacuum cleaner, a massage machine, or the like.

According to an embodiment, the processor 250 may vary the degree of adjustment of the preference, based on an operation frequency of an IoT device in use. For example, when the operation frequency of the IoT device in use is higher than or equal to a threshold frequency, the processor 250 may lower the preference more than when the operation frequency of the IoT device in use is lower than the threshold frequency. For example, when a time interval during which a refrigerator door is opened and then closed is longer than or equal to threshold time, the processor 250 may lower the preference more than when the time interval is shorter than the threshold time. In another example, when an operation frequency of a user terminal is higher than or equal to the threshold frequency, the processor 250 may lower the preference more than when the operation frequency is lower than the threshold frequency.

According to an embodiment, when the adjusted preference is lower than a specified value, the processor 250 may determine that contents need to be recommended (e.g., the user has a low interest in the contents being played). When determining that contents need to be recommended, the processor 250 may determine contents corresponding to the status information of the IoT device 110, based on contents history information and may recommend the determined contents. The contents history information may include at least one of, for example, information on the previously output contents, status information of at least one IoT device corresponding to the previously output contents, and information on a preference associated with the previously output contents. For example, the processor 250 may determine contents corresponding to the received status information, based on the contents history information and may recommend the determined contents. In another example, when identifying a plurality of contents corresponding to the received status information, the processor 250 may recommend a specified number of contents with relatively high preferences among the plurality of contents.

According to an embodiment, the processor 250 may recommend contents by a specified method, but may vary the specified method according to the magnitude of a preference associated with the contents to be recommended. For example, when the magnitude of the preference is within a first range, the processor 250 may recommend the contents by popping up a pop-up window including summary information of the recommended contents (e.g., the name of the recommended contents) in at least a specified area (e.g., at the top) of the output contents. The pop-up window may include, for example, Uniform Resource Locator (URL) information for access to the recommended contents. In another example, when the magnitude of the preference is within a second range (e.g., the low limit of the second range>the upper limit of the first range), the processor 250 may recommend the contents by popping up a Picture In Picture (PIP) window that outputs the recommended contents, in a specified area on the output contents. In another example, when the magnitude of the preference is within a third range (e.g., values in the third range>values in the second range), the processor 250 may output the recommended contents, instead of the contents being output, on the display 230 without a separate alarm.

According to an embodiment, the processor 250 may vary a method for notifying of recommendation of contents, according to the distance between the display device 200 and an IoT device in use. For example, when the IoT device in use is located less than a specified distance from the display device 200, the processor 250 may notify of information on recommended contents through a pop-up window. In another example, when the IoT device in use is located more than the specified distance from the display device 200, the processor 250 may provide information on contents to be recommended, using voice. The processor 250 may provide the information on the contents to be recommended, using voice according to the currently set volume. Alternatively, when the current volume is lower than specified volume, the processor 250 may adjust the volume to the specified volume and may provide the information on the contents to be recommended, at the adjusted volume. The specified volume may be set through the input device 220, for example, such that sounds of the display device 200 are audible even at the specified distance.

According to an embodiment, the processor 250 may associate the received status information, the information on the output contents, and the adjusted preference and may store the associated information as at least part of the contents history information in the memory 240. For example, the processor 250 may associate status information of an IoT device in use with the output contents and the adjusted preference and may store the associated information in the memory 240.

According to an embodiment, the processor 250 may identify whether the user is at home, based on the status information of the at least one IoT device 110 and only when the user is at home, the processor 250 may perform the preference adjustment function or the contents recommendation function described above. The processor 250 may determine that the user is at home, in a case where at least a part of the at least one IoT device 110 is turned on, for example, in a case where a lighting device, the display device 200, and an air conditioner are turned on. In another example, the processor 250 may communicate with the user's terminal to identify whether the user is at home.

According to an embodiment, the processor 250 may adjust a preference associated with contents, based on an input history through the input device 220. For example, the processor 250 may raise the preference associated with the contents when the contents are set to be preferred, or a schedule for the contents is set, through the input device 220. In another example, when the playback of the recommended contents is requested through the input device 220, the processor 250 may raise the preference associated with the recommended contents. In another example, when a “soccer mode” of the display device 200 is set through the input device 220, the processor 250 may raise a preference for soccer-related contents. According to various embodiments, the processor 250 may adjust a preference, based on the frequency of connection between the display device 200 and an external interface device. For example, when the frequency of connection between the display device 200 and an external memory is higher than or equal to a threshold frequency, the processor 250 may raise a preference of VOD broadcast contents rather than live broadcast contents.

According to an embodiment, in a case where recommendation settings for contents, which are set through the input device 220, are stored in the memory 240, the processor 250 may recommend contents, based on the recommendation settings. For example, as illustrated in FIG. 3, the user may set a keyword of interest to “artificial intelligence”, transmission time to “9:00 a.m.”, a receive location to “aaa@aaa.com”, a receive frequency to “once a day”, and a preferred language to “Korean” through the input device 220 of the display device 200. In this case, the processor 250 may request the at least one contents server 130 to search for contents in Korean for the keyword “artificial intelligence” before 09:00 a.m., receive the found contents from the at least one contents server 130 in response to the request, and transmit the received contents to the e-mail address “aaa@ aaa.com” at 09:00 a.m. once a day. The keyword may be set to, for example, “artificial intelligence”, “sports”, “drama”, or the like. The receive frequency may be set to, for example, “once a day”, “every time preferred contents are generated”, or the like. The receive location may be set to, for example, “display device 200”, “e-mail address”, “mobile terminal”, or the like.

According to an embodiment, in a case where the currently output contents are sports-related contents and a speaker, which is an IoT device in use, is playing music, the processor 250 may lower a preference of the sports-related contents. The processor 250 may associate the lowered preference with a music playback status of the speaker and the sports-related contents and may store the associated information in the memory 240. The preference of the sports-related contents may be lowered by the repetition of the process, with the speaker playing the music. In a case where the preference is adjusted to less than a specified value, the processor 250 may recommend contents.

According to an embodiment, the processor 250 may identify the number of times that the at least one IoT device 110 is used, based on the status information of the at least one IoT device 110 and may adjust the preference associated with the contents, based on the frequency of use. For example, the processor 250 may lower a preference of food-related contents when identifying that the number of times that a refrigerator is opened and closed is lower than the number of times that the display device 200 is turned on/off, based on the status information of the at least one IoT device 110.

According to an embodiment, the processor 250 may adjust the preference associated with the contents, based on history data of the at least one IoT device 110. For example, the processor 250 may raise a preference associated with drama contents when identifying that the Original Sound Track (OST) of the corresponding drama contents is stored in a playback list of a speaker, based on the status information of the at least one IoT device 110 while the corresponding drama contents are being output. In another example, the processor 250 may identify a list of consumed foods in a refrigerator, based on the status information of the at least one IoT device 110 and may raise a preference of contents associated with the corresponding food list. In another example, the processor 250 may receive status information including a search history (e.g., a travel search history) from a user terminal, identify the search history from the status information, and raise a preference of contents (e.g., travel-related contents) that are associated with the identified search history.

According to an embodiment, the processor 250 may identify whether an IoT device in use is relevant to the output contents, and may raise the preference when identifying that the IoT device in use is relevant to the output contents. For example, when there are one or more matching words between a function keyword (e.g., “food storage”) of an IoT device in use and overview information (e.g., EPG information) of the output contents, the processor 250 may determine that the IoT device in use is relevant to the output contents. For example, when identifying that the currently output contents are food-related contents and a door of a refrigerator, which is an IoT device in use, is opened and closed, the processor 250 may raise a preference associated with the contents, associate the adjusted preference with the refrigerator door opening/closing operation and the food-related contents, and store the associated information in the memory 240.

According to various embodiments, the processor 250 may analyze watching time for each channel and may raise a preference of contents of a channel with the longest watching time among the channels. For example, in a case where the watching frequency of a home shopping channel is relatively high, the processor 250 may raise a preference of contents relevant to products sold via the home shopping channel.

In the above-described embodiments, for contents not associated with the status information of the at least one IoT device 110 among contents with adjusted preferences, the processor 250 may identically adjust a preference for the entire status information of the at least one IoT device 110.

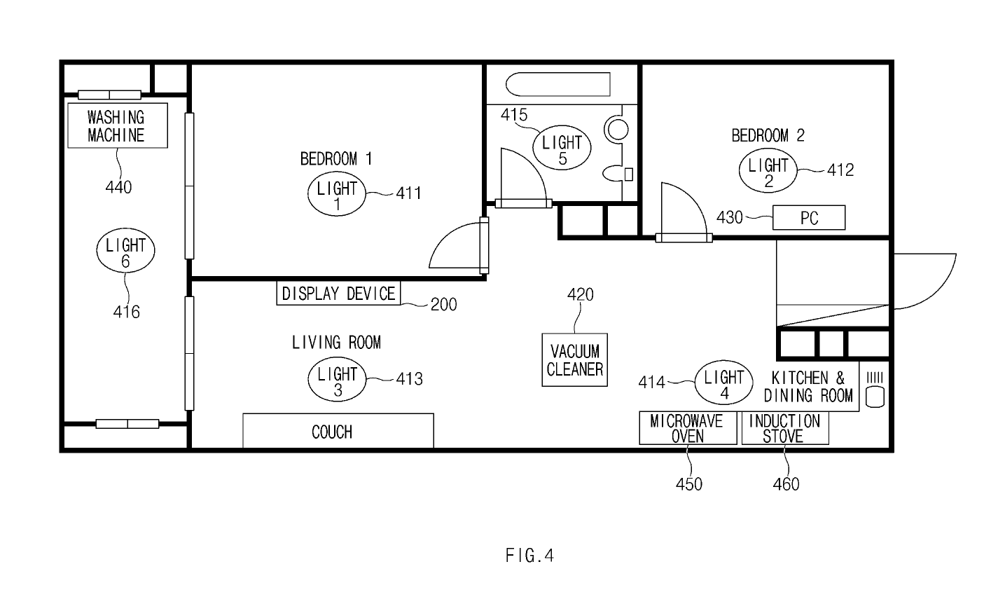

FIG. 4 is a diagram illustrating an example arrangement of a plurality of IoT devices and a display device in a home according to an embodiment.

Referring to FIG. 4, the plurality of IoT devices (e.g., the at least one IoT device 110 of FIG. 1) disposed in the home may include, for example, lights 1, 3, 2, 4, 5 and 6 (411, 412, 41, 414, 415 and 416), a vacuum cleaner 420, a Personal Computer (PC) 430, a microwave oven 450, an induction stove 460, a display device 200, and a washing machine 440. The lights 1, 2, 3, 4, 5 and 6 (411, 412, 413, 414, 415 and 416), the PC 430, the microwave oven 450, the induction stove 460, and the washing machine 440 may be fixedly-installed IoT devices. The vacuum cleaner 420 may be a movable IoT device.

According to an embodiment, the processor 250 may receive the layout of the home, in which the plurality of IoT devices are installed, from a server device via the second communication circuitry 212. The processor 250 may receive, through the input device 220, user inputs for setting the positions of the fixedly-installed IoT devices in the layout of the home, identify position information of the fixedly-installed IoT devices in the home according to the user input, and store the identified position information of the fixedly-installed IoT devices in the memory 240. The processor 250 may receive, through the input device 220, a user input for setting the position of the display device 200 in the layout, identify position information of the display device 200 according to the received user input, and store the identified position information of the display device 200 in the memory 240. The processor 250 may identify the distances between the display device 200 and the fixedly-installed IoT devices, based on the position information set by the user inputs and the spatial size of furniture according to the layout. The processor 250 may identify the distance between the vacuum cleaner 420 and the display device 200 by using receiving sensitivity for the movable vacuum cleaner 420. According to various embodiments, the vacuum cleaner 420 may communicate with the fixedly-installed IoT devices 411, 412, 413, 414, 415 and 416, 430, 440, 450, and 460 in the home while moving, identify the position information of the fixedly-installed IoT devices 411, 412, 413, 414, 415 and 416, 430, 440, 450, and 460 in the home using, for example, signal strengths, and transmit the identified position information to the display device 200, and the processor 250 may receive the position information from the vacuum cleaner 420 and may identify the position information of the fixedly-installed IoT devices 411, 412, 413, 414, 415 and 416, 430, 440, 450, and 460 in the home and the distances between the display device 200 and the fixedly-installed IoT devices 411, 412, 413, 414, 415 and 416, 430, 440, 450, and 460 in the home. A relationship between the signal strengths and the distances may be experimentally identified.

According to an embodiment, the processor 250 may receive at least one of a specified distance or specified volume that is input through the input device 220. The specified distance may be, for example, a distance at which a user cannot watch the display device 200, and may be set by the user. For example, the specified distance may be set to be the distance between the display device 200 and the light 1 (411).

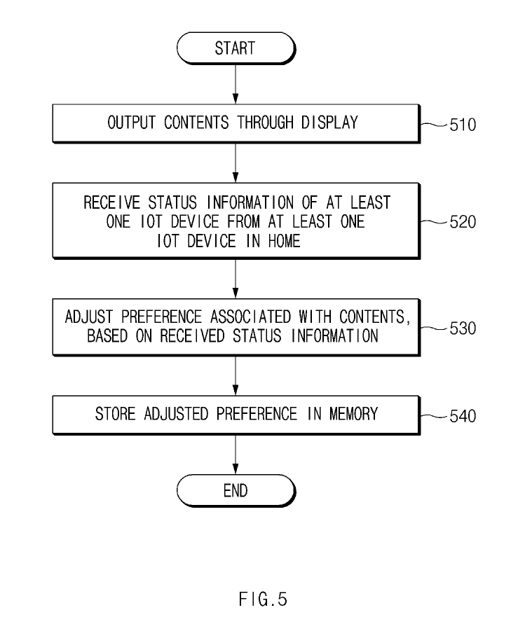

FIG. 5 is a flowchart illustrating an example method for identifying a preference for IoT-based contents according to an embodiment.

Referring to FIG. 5, in operation 510, the processor 250 may output contents through the display 230.

In operation 520, the processor 250 may receive status information of the at least one IoT device 110 from the at least one IoT device 110 in the home.

In operation 530, the processor 250 may adjust a preference associated with the contents, based on the received status information. For example, the processor 250 may lower the preference associated with the contents when identifying that an IoT device in use is present, based on the received status information. In another example, the processor 250 may raise the preference associated with the contents in a case where the relevance of the identified IoT device in use to the contents is higher than or equal to threshold relevance. In another example, the processor 250 may raise the preference associated with the contents when identifying that there is no IoT device in use, based on the received status information.

In operation 540, the processor 250 may control the memory 240 to store the adjusted preference. For example, the processor 250 may associate the adjusted preference with the status information of the IoT device causing the preference adjustment and information of the contents associated with the preference and may store the associated information, for example, as part of contents history information.

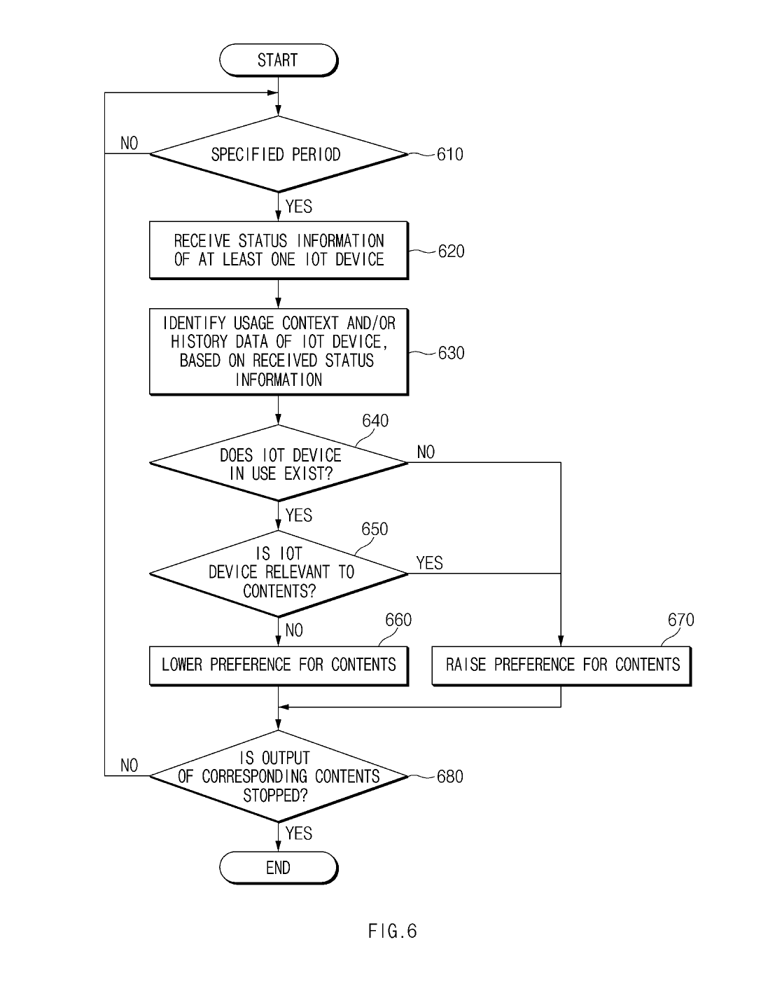

FIG. 6 is a flowchart illustrating an example method for adjusting a preference associated with contents according to an embodiment. For example, the processor 250 may perform operations 610, 620, 630, 640, 650, 660, 670 and 680 when output contents exist.

Referring to FIG. 6, in operation 610, the processor 250 may identify whether a specified period arrives.

In operation 620, the processor 250 may receive status information of at least one IoT device. For example, the processor 250 may request status information from the at least one IoT device 110 and may receive the status information from the at least one IoT device 110 in response to the request. The status information may include at least one of, for example, operation time information, operation content information, or selected data content (e.g., a playback list, a search history, or the like).

In operation 630, the processor 250 may identify at least one of usage context and/or history data of the at least one IoT device 110, based on the received status information. For example, the processor 250 may identify driving time or operation time, based on the received status information and may identify whether an IoT device in use is present, based on the driving time or the operation time. In another example, the processor 250 may identify the history data (e.g., the playback list, the search history, or the like) that is identified based on the received status information.

In operation 640, the processor 250 may identify whether an IoT device in use is present (e.g., does an IoT device in use exist). For example, the processor 250 may identify driving time or operation time, based on the received status information and may determine an IoT device, the driving time or the operation time of which overlaps output time of the contents of the display device 200, as an IoT device in use.

When identifying that an IoT device in use is present, the processor 250 may, in operation 650, identify whether the IoT device in use is relevant to the contents. For example, when there are one or more matching words between a function keyword (e.g., “food storage”) of the IoT device in use and overview information (e.g., Electric Program Guide (EPG) information) of the output contents, the processor 250 may determine that the IoT device in use is relevant to the output contents.

When the processor 250, in operation 650, identifies that the IoT device in use is irrelevant to the contents, the processor 250 may, in operation 660, lower a preference associated with the output contents.

When the processor 250, in operation 640, identifies that there is no IoT device in use or, in operation 650, identifies that the IoT device in use is relevant to the contents, the processor 250 may, in operation 670, raise the preference associated with the output contents. For example, when there are one or more matching words in meaning between the history data and the information (e.g., the EPG information) of the contents, the processor 250 may determine that the IoT device in use is relevant to the contents.

In operation 680, the processor 250 may identify whether the output of the contents is stopped and may perform operation 610 when identifying that the output of the contents is not stopped.

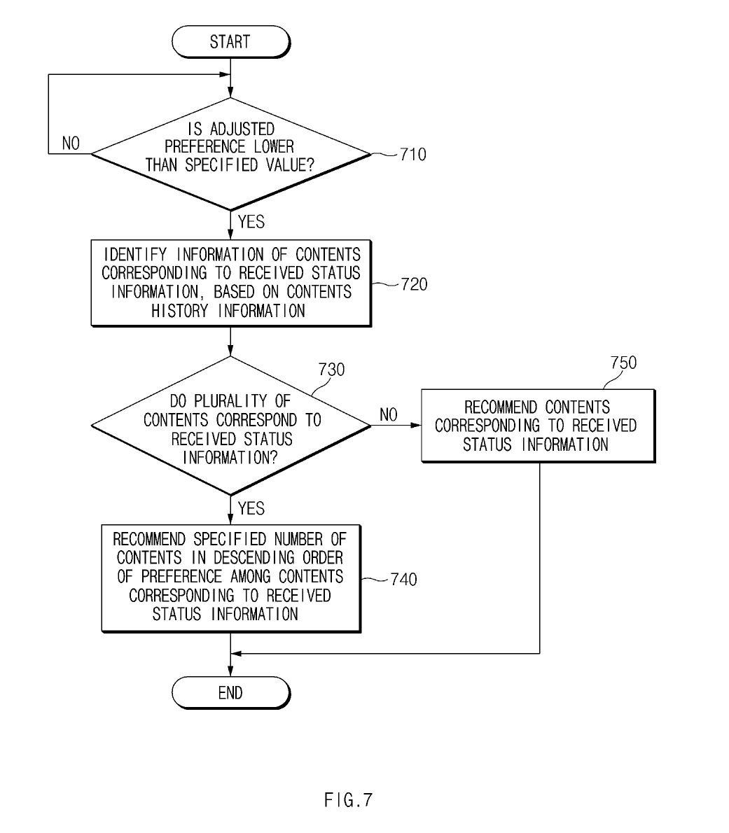

FIG. 7 is a flowchart illustrating an example method for recommending contents according to an embodiment. For example, the method of FIG. 7 may be performed after the performance of the method of FIG. 5, but the disclosure is not limited thereto.

Referring to FIG. 7, in operation 710, the processor 250 may identify whether the adjusted preference is lower than a specified value. The specified value may be one or more values.

In operation 720, the processor 250 may identify information of the contents corresponding to the received status information, based on the contents history information when the adjusted preference is determined to be lower than a specified value in operation 710. The contents history information may include, for example, information on the previously output contents, status information of at least one IoT device corresponding to the previously output contents, and information on a preference associated with the previously output contents.

In operation 730, the processor 250 may identify whether a plurality of contents correspond to the received status information. When the processor 250, in operation 730, identifies that a plurality of contents correspond to the received status information, the processor 250 may, in operation 740, recommend a specified number of (e.g., two) contents in descending order of preference among the plurality of contents corresponding to the received status information.

When the processor 250, in operation 730, identifies that one piece of contents correspond to the received status information, the processor 250 may, in operation 750, recommend the contents corresponding to the received status information.

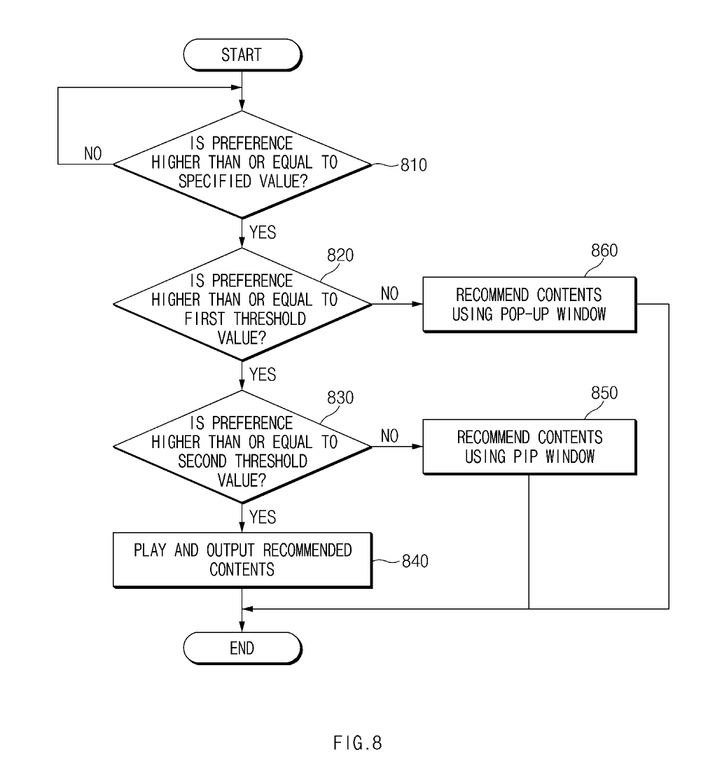

FIG. 8 is a flowchart illustrating an example method for recommending contents in accordance with the magnitude of a preference according to an embodiment. FIG. 8 relates to an example of various methods for recommending contents after determining to recommend the contents, but the disclosure is not limited thereto.

Referring to FIG. 8, in operation 810, the processor 250 may identify whether a preference is higher than or equal to a specified value (e.g., 60). The specified value may be, for example, a reference preference value for determining whether to recommend contents.

When identifying that the preference is higher than or equal to the specified value, the processor 250 may, in operation 820, identify whether the preference is higher than or equal to a first threshold value (e.g., 70).

When identifying that the preference is higher than or equal to the first threshold value, the processor 250 may, in operation 830, identify whether the preference is higher than or equal to a second threshold value (e.g., 80).

When identifying that the preference is higher than or equal to the second threshold value, the processor 250 may, in operation 840, play recommended contents and output the contents on the display 230.

When identifying that the preference is higher than or equal to the first threshold value and lower than the second threshold value, the processor 250 may, in operation 850, recommend contents in a Picture In Picture (PIP), window for outputting recommended contents, in a specified area on output contents.

When identifying that the preference is lower than the first threshold value, the processor 250 may, in operation 860, recommend contents using a pop-up window including summary information of recommended contents, in a specified area (e.g., at the top) of the output contents. The pop-up window may include, for example, URL information for access to the recommended contents.

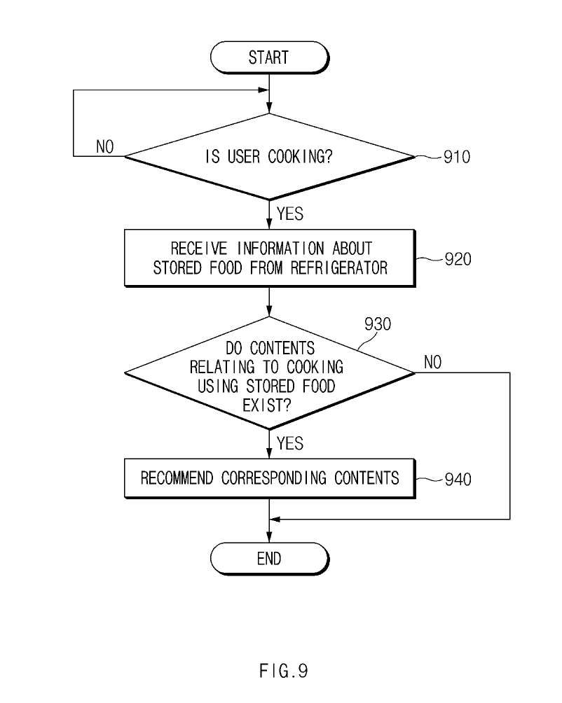

FIG. 9 is a flowchart illustrating an example method for recommending contents in accordance with user context according to an embodiment.

Referring to FIG. 9, in operation 910, the processor 250 may identify whether a user is cooking, based on status information of at least one IoT device. For example, when identifying that refrigerator opening/closing time is shorter than threshold time, based on the status information of the at least one IoT device, the processor 250 may determine that the user is cooking. In another example, when identifying that cooking equipment such as a microwave oven, a gas stove, or an induction stove is operating, based on the status information of the at least one IoT device, the processor 250 may determine that the user is cooking.

When determining that the user is cooking, the processor 250 may, in operation 920, receive information about stored food from the refrigerator. For example, the processor 250 may request the information about the stored food from the refrigerator and may receive the information about the stored food from the refrigerator in response to the request.

In operation 930, the processor 250 may identify whether contents relating to cooking using the stored food exist. For example, the processor 250 may set a keyword to “stored food” and may identify whether contents corresponding to the keyword exist, based on EPG information of the contents.

When identifying that contents relating to cooking using the stored food exist, the processor 250 may, in operation 940, recommend the corresponding contents. The contents may include at least one of, for example, real-time broadcast contents, VOD broadcast contents, or web page contents.

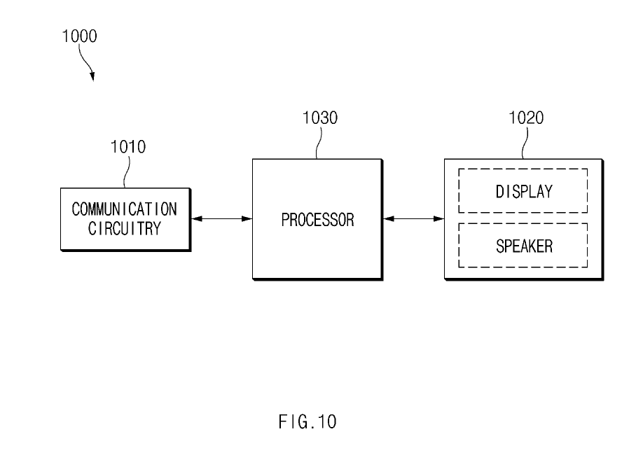

FIG. 10 is a block diagram illustrating an example configuration of a display device 1000 according to an embodiment.

Referring to FIG. 10, according to an embodiment, the display device 1000 may include an output device (e.g., including output circuitry) 1020 (e.g., the display 230 of FIG. 2), communication circuitry 1010 (e.g., the communication circuitry 210 of FIG. 2), and a processor (e.g., including processing circuitry) 1030 (e.g., the processor 250 of FIG. 2).

According to an embodiment, the communication circuitry 1010 may communicate with at least one external device (e.g., the at least one IoT device 110 of FIG. 1) or a server device (e.g., the server device 140 of FIG. 1). The at least one external device may include an Internet of Things (IoT) terminal. The server device may be a server (e.g., a home network server) that is capable of relaying the communication between the at least one external device and the display device 1000.

According to an embodiment, the output device 1020 may include various output circuitry, such as, for example, and without limitation, at least one of a display and a speaker, or the like.

According to an embodiment, the processor 1030 may include various processing circuitry and identify at least one of first preference information, second preference information, or third preference information. The first preference information may include, for example, contents preference information input by a user. For example, the first preference information may be input through a recommendation setting UI that is provided through a screen of the display. The recommendation setting UI (see FIG. 3) may include input items for one or more of keyword information of interest, transmission time information, receive location information, receive frequency information, and preferred language information. The first preference information may include at least one of keyword information of interest, transmission time information, receive location information, receive frequency information, or preferred language information. The second preference information may be control information of the display device 1000 or playback history information of contents output on the output device 1020. The control information of the display device 1000 may include at least one of, for example, watching time for each channel or setting information (e.g., turned on a soccer mode) for the display device 1000. The playback history information of the contents may include at least one of, for example, genre information or playback time information of the contents being played. The third preference information may be information received from the at least one external device or the server device. For example, the third preference information may include preference information obtained from at least one of setting-related information, operation-status-related information, or usage pattern information of the IoT terminal.

According to an embodiment, the processor 1030 may determine the user's preference, based on at least one of the first preference information, the second preference information, or the third preference information. For example, the processor 1030 may determine the user's preference that includes at least one of the preferred language information or the keyword information of interest that is included in the first preference information.

According to an embodiment, the processor 1030 may learn the user's preference through a machine learning algorithm, based on at least one of the first preference information, the second preference information, or the third preference information. For example, the processor 1030 may learn at least one of preferred genre information or keyword information of interest of the user, based on the control information of the display device 1000 or the playback history information of the contents that is included in the second preference information. In another example, the processor 1030 may learn usage pattern information (behavior pattern information of the user), based on at least one of the setting-related information or the operation-status-related information of the IoT terminal that is included in the third preference information. In another example, the processor 1030 may learn information of interest (e.g., a location or information of interest of the user) for each time range, based on at least one of the setting-related information, the operation-status-related information, or the usage pattern information of the IoT terminal.

In an embodiment, the processor 1030 may determine the user's preference, based on a learning result for at least one of the first preference information, the second preference information, or the third preference information. For example, the processor 1030 may determine the user's preference (e.g. a preferred priority) for a genre or a keyword of contents for each time range, based on a result obtained by learning the user's preference for the preferred genre information, the keyword information of interest, or the information of interest for each time range.

According to an embodiment, the processor 1030 may determine reception setting information of contents information of interest corresponding to the user's preference, based on at least one of the first preference information, the second preference information, or the third preference information and may determine the user's preference for the reception setting information. For example, based on transmission time information, receive location information, receive frequency information, or preferred language information input through the recommendation setting UI, the processor 1030 may identify reception setting information that includes at least one of receive time, a receive location, a receive frequency, or a language of contents information of interest that is preferred by the user. The receive location may include, for example, the display device 1000, an e-mail address, a mobile terminal, or the like.

According to an embodiment, the processor 1030 may transmit the determined preference of the user (e.g., the preferred priority information and the reception setting information for the contents) to the server device (e.g., the server device 140 of FIG. 1) via the communication circuitry 1010 and may receive contents information of interest corresponding to the user's preference from the server device (e.g., the server device 140 of FIG. 1). In an embodiment, the server device may identify the keyword information of interest or the preferred language information that is included in the user's preference, communicate with a contents server (e.g., the contents server 130 of FIG. 1) to search for contents corresponding to the keyword information of interest or the preferred language information, and generate information on the found contents (contents information of interest). The server device may transmit the generated contents information of interest to the receive location every receive frequency at the time according to the reception setting information. The contents information of interest may include at least one of a contents title, summary information, or playback time.

According to an embodiment, the processor 1030 may output the received contents information of interest or notification for the received contents information of interest through the output device 1020. For example, the processor 1030 may output, through the output device 1020, at least one of a UI displayed on the screen of the display or a sound output through the speaker.

According to an embodiment, the processor 1030 may determine the user's location, based on information (e.g., operation-status-related information) received from at least one IoT terminal. For example, in the case of an IoT terminal (e.g., a refrigerator or cooking equipment) that requires the user's manual operation, the processor 1030 may determine the location of an IoT terminal being used by the user to be the user's location, based on operation-status-related information. For example, when receiving the contents information of interest from the server device, the processor 1030 may predict the user's location, based on IoT status information.

The processor 1030 may differently determine a notification output method through the output device 1020 according to the determined location of the user. For example, in a case where the user is located less than specified distance from the display device 1000, the processor 1030 may display the summary information of the contents information of interest on the display. In another example, in a case where the user is located more than the specified distance from the display device 1000, the processor 1030 may provide the summary information of the contents information of interest using voice. The processor 1030 may increase the output of a guide sound according to the distance between the user and the display device 1000. In another example, the processor 1030 may provide the summary information of the contents information of interest to the user through an IoT device (an output device thereof) that is being used by the user, according to the user's location.

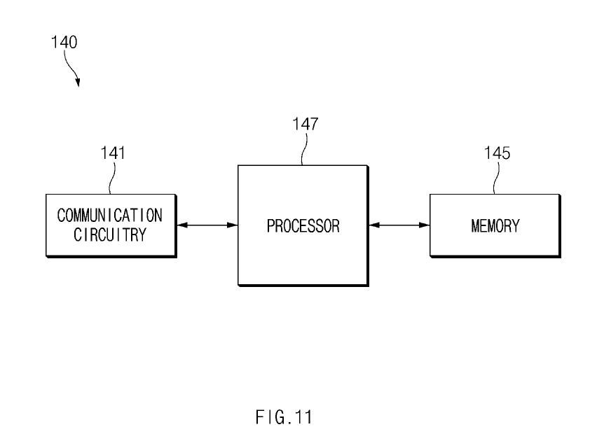

FIG. 11 is a block diagram illustrating an example configuration of a server device (e.g., the server device 140 of FIG. 1) according to an embodiment.

Referring to FIG. 11, according to an embodiment, the server device 140 may include communication circuitry 141, a memory 145, and a processor (e.g., including processing circuitry) 147.

According to an embodiment, the communication circuitry 141 may communicate with the at least one IoT device 110, the at least one contents server 130, or a display device (e.g., the display device 1000 of FIG. 10). The communication circuitry 141 may perform the communication via at least one communication channel of a broadcast communication network or an Internet network.

According to an embodiment, the memory 145 may store commands or data associated with at least one other component of the server device 140.

According to an embodiment, the processor 147 may include various processing circuitry and decide (determine) a user's preference, based on at least one of information of the at least one IoT device 110 received via the communication circuitry 141 or information received from the display device 1000 and may generate contents information of interest that corresponds to the user's preference.

According to an embodiment, the processor 147 may collect, via the communication circuitry 141, at least one piece of status information among setting-related information or operation-status-related information of a plurality of IoT devices. For example, the server device 140 may collect status information of a plurality of IoT devices included in a home or related to the user.

According to an embodiment, the processor 147 may receive at least one of first preference information or second preference information from the display device 1000. The first preference information may include at least one of, for example, keyword information of interest, transmission time information, receive location information, receive frequency information, or preferred language information that is input by the user. The second preference information may be, for example, control information of the display device 1000 or playback history information of contents output on the output device 1020.

According to an embodiment, the processor 147 may learn the user's preference through a machine learning algorithm, based on at least one of the first preference information, the second preference information, or the third preference information. For example, the processor 147 may learn at least one of preferred genre information or keyword information of interest of the user, based on the control information of the display device 1000 or the playback history information of the contents that is included in the second preference information, and may determine the user's preference including at least one of the preferred genre information or the keyword information of interest. In another example, the processor 147 may learn usage pattern information (behavior pattern information of the user), based on at least one of setting-related information or operation-status-related information of an IoT terminal that is included in third preference information. In another example, the processor 147 may learn information of interest (e.g., a location or information of interest of the user) for each time range, based on at least one of setting-related information, operation-status-related information, or usage pattern information of an IoT terminal.

According to an embodiment, the processor 147 may determine the user's preference, based on a learning result for at least one of the first preference information, the second preference information, or the third preference information. For example, based on a result obtained by learning the user's preference for the preferred genre information, the keyword information of interest, or the information of interest for each time range, the processor 147 may determine the user's preference (e.g. a preferred priority) for a genre or a keyword of contents for each time range.

According to an embodiment, for example, based on the transmission time information, the receive location information, the receive frequency information, or the preferred language information that is included in the first preference information, the processor 147 may identify reception setting information that includes at least one of receive time, a receive location, a receive frequency, or a language of contents information of interest that is preferred by the user. The receive location may include, for example, the display device 1000, an e-mail address, a mobile terminal, or the like.

According to an embodiment, the processor 147 may search a contents server (e.g., the contents server 130 of FIG. 1) for contents for which the user's preference is relatively high, based on at least one of the preferred genre information, the keyword information of interest, or the preferred language information and may generate contents information of interest for the found contents. For example, the processor 147 may search for contents that correspond to a keyword or a genre for which the user's preference is relatively high for each time range and that are configured in a preferred language, and may generate contents information of interest for the found contents. The processor 147 may transmit the generated contents information of interest to the receive location via the communication circuitry 141 every receive frequency at the time according to the reception setting information. The contents information of interest may include at least one of a contents title, summary information, or playback time.

According to an embodiment, a display device (e.g., the display device 200 of FIG. 2) comprises an output device (e.g., the output device 1020 of FIG. 10); communication circuitry (e.g., the communication circuitry 1010 of FIG. 10) configured to communicate with at least one external device or an external server; and a processor (e.g., the processor 1030 of FIG. 10) operatively coupled with the output device and the communication circuitry, wherein the processor is configured to identify a user's preference, based on at least one of first preference information, second preference information, or third preference information, wherein the first preference information includes contents preference information by a user input, the second preference information includes control information of the display device or playback history information of contents output on the output device, and the third preference information includes information received from the at least one external device or the external server; receive contents information of interest corresponding to the user's preference from the external server via the communication circuitry; and output the received contents information of interest or notification for the received contents information of interest through the output device.

The output device may include at least one of a display or a speaker, and wherein the processor is configured to output at least one of a user interface (UI) displayed on the display or a sound output through the speaker.

The first preference information may be input through a recommendation setting UI that is provided through the output device, and wherein the recommendation setting UI includes one or more input items among a keyword of interest, transmission time, a receive location, a receive frequency, and a language.

The at least one external device may include an Internet of Things (IoT) terminal, and wherein the third preference information includes at least one of setting-related information, operation-status-related information, or usage pattern information of the IoT terminal.

The processor may be configured to identify a location of the user, based on information received from the IoT terminal and determines a notification output method through the output device according to the verified location of the user.

According to an embodiment, a server (e.g., the server device 140 of FIG. 11) for providing contents of interest, the server comprises communication circuitry (e.g., the communication circuitry 141 of FIG. 11) configured to communicate with at least one external IoT terminal and a display device; and a processor (e.g., the processor 147 of FIG. 11), wherein the processor is configured to identify a user's preference, based on at least one of information received from the display device or information received from the at least one external IoT terminal; generate contents information of interest corresponding to the identified preference of the user; and transmit the generated contents information of interest or notification for the generated contents information of interest to the display device or the at least one external IoT terminal via the communication circuitry.

The information received from the display device may include first preference information including contents preference information by a user input; and second preference information that includes control information of the display device or playback history information of contents output on an output device, and wherein the information received from the at least one external IoT terminal includes third preference information that includes at least one of setting-related information, operation-status-related information, or usage pattern information of the at least one external IoT terminal.

The processor may be configured to identify a location of the user, based on the information received from the at least one external IoT terminal and determines notification information according to the identified location of the user.

The contents information of interest may include at least one of a contents title, summary information, or playback time, and wherein the processor learns the user's preference for a genre or a keyword of contents for each time range through a machine learning algorithm, based on the first to third preference information and generates the contents information of interest for contents with a genre or a keyword for which the user's preference is relatively high, for each time range.

According to an embodiment, a display device (e.g., the display device 200 of FIG. 2) comprises a memory (e.g., the memory 240 of FIG. 2); a display (e.g., the display 230 of FIG. 2); communication circuitry (e.g., the communication circuitry 210 of FIG. 2) configured to communicate with at least one IoT device; and a processor (e.g., the processor 250 of FIG. 2) operatively coupled with the memory, the display, and the communication circuitry, wherein the processor is configured to output contents through the display; receive status information of the at least one IoT device via the communication circuitry; adjust a preference associated with the contents, based on the received status information; and store the adjusted preference in the memory.

The processor may be configured to identify at least one information among a type of the at least one IoT device, operation time of the at least one IoT device and a distance from the display device, based on the received status information; and lower or raise the preference according to the at least one information.

The processor may be configured to obtain overview information of the contents from the memory; identify whether the at least one IoT device is relevant to the contents, based on the overview information of the contents; and raise or lower the preference according to the relevance of the IoT device in use to the contents.

The processor may be configured to determine that the at least one IoT device is relevant to the contents, when a mutually identical or similar word is contained in the overview information of the contents and function information of the at least one IoT device.

The processor may be configured to identify input history data of the at least one IoT device, based on the received status information; identify whether the identified input history data is relevant to the contents, based on the overview information of the contents; and raise or lower the preference when it is identified that the input history data is relevant to the contents.

The processor may be configured to raise the preference when storing of information relevant to the contents is identified, based on the input history data.

The processor may be configured to vary an output method of contents recommendation information according to a magnitude of the preference associated with contents to be recommended.

The display device further comprises input device (e.g., the input device 220 of FIG. 2), and the processor is configured to raise the preference when the contents are reserved through the input device.

According to various example embodiments of the disclosure, a preference for contents may be identified based on status information of an IoT device. In addition, the present disclosure may provide various effects that are directly or indirectly recognized.

According to various embodiments, at least a part of an apparatus (e.g., modules or functions thereof) or a method (e.g., operations) may be, for example, implemented by instructions stored in a computer-readable storage media in the form of a program module. The instruction, when executed by a processor, may cause the processor to perform a function corresponding to the instruction. The computer-readable recording medium may include a hard disk, a floppy disk, a magnetic media (e.g., a magnetic tape), an optical media (e.g., a compact disc read only memory (CD-ROM) and a digital versatile disc (DVD), a magneto-optical media (e.g., a floptical disk)), an embedded memory, and the like. The one or more instructions may contain a code made by a compiler or a code executable by an interpreter. A module or a program module according to various embodiments may include at least one of the above elements, or a part of the above elements may be omitted, or other elements may be further included.

Operations performed by a module, a program module, or other elements according to various embodiments may be executed sequentially, in parallel, repeatedly, or in a heuristic method. In addition, some of the operations may be executed in different sequences or may be omitted. Alternatively, other operations may be added. Embodiments of the present disclosure are provided merely to easily describe technical details of the present disclosure and to aid in the understanding of the present disclosure, and are not intended to limit the scope of the present disclosure. Therefore, it should be understood that all modifications and changes or various other embodiments based on the technical idea of the present disclosure fall within the scope of the present disclosure.

While the present disclosure has been illustrated and described with reference to various example embodiments thereof, it will be understood by those skilled in the art that various changes in form and details may be made therein without departing from the spirit and scope of the present disclosure as defined, for example, by the appended claims and their equivalents.

What is claimed is:

1. A display device comprising:
an output device comprising output circuitry;
communication circuitry configured to communicate with at least one external device or an external server; and
a processor operatively coupled with the output device and the communication circuitry,
wherein the processor is configured to:
identify a user's preference, based on at least one of: first preference information, second preference information, and third preference information, wherein the first preference information includes contents preference information input by a user, the second preference information includes control information of the display device and/or playback history information of contents output on the output device, and the third preference information includes information received from the at least one external device and/or the external server;
receive contents information of interest corresponding to the user's preference from the external server via the communication circuitry; and
output the received contents information of interest and/or notification for the received contents information of interest through the output device.

2. The display device of claim 1, wherein the output device includes at least one of: a display and a speaker, and
wherein the processor is configured to control the display device to output at least one of a user interface (UI) on the display and a sound output through the speaker.

3. The display device of claim 1, wherein the display device is configured to receive an input of the first preference information through a recommendation setting UI provided through the output device, and
wherein the recommendation setting UI includes one or more input items among a keyword of interest, transmission time, a receive location, a receive frequency, and a language.

4. The display device of claim 1, wherein the at least one external device includes an Internet of Things (IoT) terminal, and
wherein the third preference information includes at least one of: setting-related information, operation-status-related information, and usage pattern information of the IoT terminal.

5. The display device of claim 4, wherein the processor is configured to identify a location of the user based on information received from the IoT terminal and to determine a notification output method through the output device based on the identified location of the user.

6. A server configured to provide contents of interest, the server comprising:
communication circuitry configured to communicate with at least one external IoT terminal and a display device; and
a processor,
wherein the processor is configured to:
identify a user's preference based on at least one of: information received from the display device and information received from the at least one external IoT terminal;
generate contents information of interest corresponding to the identified preference of the user; and
transmit the generated contents information of interest and/or notification for the generated contents information of interest to the display device and/or the at least one external IoT terminal via the communication circuitry.

7. The server of claim 6, wherein the information received from the display device includes:
first preference information including contents preference information input by a user; and
second preference information including control information of the display device and/or playback history information of contents output on an output device, and
wherein the information received from the at least one external IoT terminal includes:
third preference information including at least one of: setting-related information, operation-status-related information, and usage pattern information of the at least one external IoT terminal.

8. The server of claim 6, wherein the processor is configured to identify a location of the user based on the information received from the at least one external IoT terminal and to determine notification information based on the identified location of the user.

9. The server of claim 7, wherein the contents information of interest includes at least one of: a contents title, summary information, and playback time, and
wherein the processor is configured to learn the user's preference for a genre and/or a keyword of contents for each time range through a machine learning algorithm, based on the first, second and third preference information and to generate the contents information of interest for contents with a genre and/or a keyword for which the user's preference is greater than a specified value for each time range.

10. A display device comprising:
a memory;
a display;
communication circuitry configured to communicate with at least one IoT device; and
a processor operatively coupled with the memory, the display, and the communication circuitry,
wherein the processor is configured to:
control the display to output contents;
receive status information of the at least one IoT device via the communication circuitry;
adjust a preference associated with the contents based on the received status information; and
control the memory to store the adjusted preference in the memory.

11. The display device of claim 10, wherein the processor is configured to:
identify at least one information among a type of the at least one IoT device, operation time of the at least one IoT device and a distance from the display device based on the received status information; and
lower or raise the preference based on the at least one information.

12. The display device of claim 10, wherein the processor is configured to:
obtain overview information of the contents from the memory;
identify whether the at least one IoT device is relevant to the contents based on the overview information of the contents; and
raise or lower the preference based on the relevance of the IoT device to the contents.

13. The display device of claim 12, wherein the processor is configured to:
determine that the at least one IoT device is relevant to the contents based on a mutually identical or similar word being contained in the overview information of the contents and function information of the at least one IoT device.

14. The display device of claim 12, wherein the processor is configured to:
identify input history data of the at least one IoT device based on the received status information;
identify whether the identified input history data is relevant to the contents based on the overview information of the contents; and
raise or lower the preference based on identifying that the input history data is relevant to the contents.

15. The display device of claim 14, wherein the processor is configured to:
raise the preference when storing of information relevant to the contents is identified based on the input history data.

16. The display device of claim 10, wherein the processor is configured to:
vary an output method of contents recommendation information based on a magnitude of the preference associated with contents to be recommended.
